(19) United States
(12) Patent Application Publication
(10) Pub. No.: US 2012/0070246 A1
(43) Pub. Date: Mar. 22, 2012

(54) SCREW AND NUT ASSEMBLY

(76) Inventor: Chun Ta PENG, Zhongli City (TW)

(21) Appl. No.: 13/229,649

(22) Filed: Sep. 9, 2011

(30) Foreign Application Priority Data
Sep. 17, 2010 (TW) 099217997

(51) Int. Cl. F16B 39/22

(52) U.S. Cl. 411/246; 411/255

(57) ABSTRACT

A screw and nut assembly includes a screw, a nut and a spacer. The nut has a central through hole and an annular fastening portion extending from one end thereof. The annular fastening portion has a plurality of grooves thereon. The spacer has a central hole and an annular concave portion next to the central hole. The screw penetrates the spacer and the nut, and then the nut is tightly screwed to the screw. When the screw and the nut are locked, the nut is moved toward the spacer. The annular fastening portion of the nut is confined by the annular concave portion of the spacer and compressed inward. Through the grooves, the annular fastening portion is compressed inward, so that the inner edge of the annular fastening portion engages with the outer threaded body of the screw tightly to prevent disengagement.

### BACKGROUND OF THE INVENTION

1. Field of the Invention

The present invention relates to a screw and nut assembly which cannot be loosened easily.

2. Description of the Prior Art

A screw and a nut are widely used to lock many objects, such as machine, furniture, vehicle, lamp, and so on. Sometimes, the screw and nut are loosened unexpectedly to cause malfunction of machines or to harm the user. Obviously, how to maintain the connection of the screw and nut is very important. After locked, the screw and nut can be bonded by means of adhesive. After a long period of time, the adhesive may be fragile to lose efficacy, which causes disengagement of the screw and nut. Accordingly, the inventor of the present invention has devoted himself based on his many years of practical experiences to solve these problems.

### SUMMARY OF THE INVENTION

The primary object of the present invention is to provide a screw and nut assembly which can prevent disengagement to ensure an object to be operated normally.

In order to achieve the aforesaid object, the present invention comprises a screw, a nut and a spacer.

Preferably, the screw comprises a screw head and an outer threaded body connected to one end of the screw head. The outer threaded body is in a cylindrical shape.

Preferably, the nut has a central through hole and inner threads on an inner wall of the through hole for connection of the outer threaded body. The nut further has an annular fastening portion extending from one end thereof. The annular fastening portion has an outer side which is gradually reduced toward a distal end thereof. The annular fastening portion has a plurality of grooves thereon. The grooves are disposed in a radial form.

Preferably, the spacer has a central hole and an annular concave portion next to the central hole.

The screw penetrates the central hole of the spacer and the through hole of the nut, and then the nut is screwed to the screw. The annular fastening portion is received in the annular concave portion. The annular concave portion doesn't face the screw. When the screw and the nut are gradually locked, the nut is moved toward the spacer. The annular fastening portion of the nut is confined by the annular concave portion of the spacer and pressed inward. Through the grooves, the annular fastening portion is compressed inward, so that the inner edge of the annular fastening portion engages with the outer threaded body of the screw tightly to prevent disengagement.

Preferably, the annular fastening portion has a side surface and a bottom surface. The spacer includes a side surface and a lower surface next to the central hole. The side surface of the annular fastening portion and the side surface of the spacer are at different angles.

The side surface of the annular fastening portion and the side surface of the spacer are in the shape of a bowl.

When the nut and the spacer are assembled, the annular concave portion of the spacer facilitates the annular fastening portion to be deformed inward. The means includes changes of the configuration, shape, angle and size of the annular concave portion and the annular fastening portion.

### BRIEF DESCRIPTION OF THE DRAWINGS

FIG. 1 is an exploded view according to a first embodiment of the present invention;

FIG. 2 is a sectional view according to the first embodiment of the present invention;

FIG. 3 is an enlarged view according to the first embodiment of the present invention;

FIG. 4 is another enlarged view according to the first embodiment of the present invention;

FIG. 5 is an exploded view according to a second embodiment of the present invention;

FIG. 6 is a sectional view according to the second embodiment of the present invention;

FIG. 7 is an exploded view according to a third embodiment of the present invention; and

FIG. 8 is a sectional view according to the third embodiment of the present invention.

### DETAILED DESCRIPTION OF THE PREFERRED EMBODIMENTS

Embodiments of the present invention will now be described, by way of example only, with reference to the accompanying drawings.

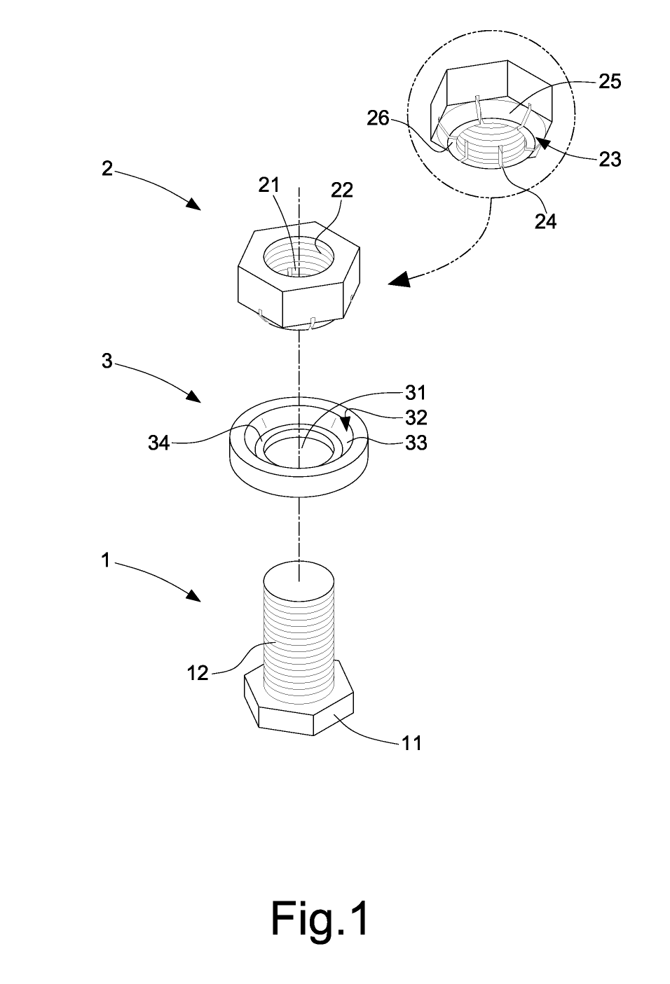

As shown in FIG. 1, the screw and nut assembly according to a first embodiment of the present invention comprises a screw 1, a nut 2, and a spacer 3.

The screw 1 comprises a screw head 11 and an outer threaded body 12 connected to one end of the screw head 11. The outer threaded body 12 is in a cylindrical shape.

The nut 2 has a central through hole 21 and inner threads 22 on an inner wall of the through hole 21 for connection of the outer threaded body 12. The nut 2 further has an annular fastening portion 23 extending from one end thereof. The annular fastening portion 23 has an outer side which is gradually reduced toward a distal end thereof. The annular fastening portion 23 has a plurality of grooves 24 thereon. The grooves 24 are equally spaced. The grooves 24 are disposed in a radial form. Preferably, the annular fastening portion 23 has a side surface 25 and a bottom surface 26 which is connected with a lower edge of the side surface 25.

The spacer 3 has a central hole 3 for insertion of the outer threaded body 12 and an annular concave portion 32 next to the central hole 31. Preferably, the annular concave portion 32 includes a side surface 33 and a lower surface 34.

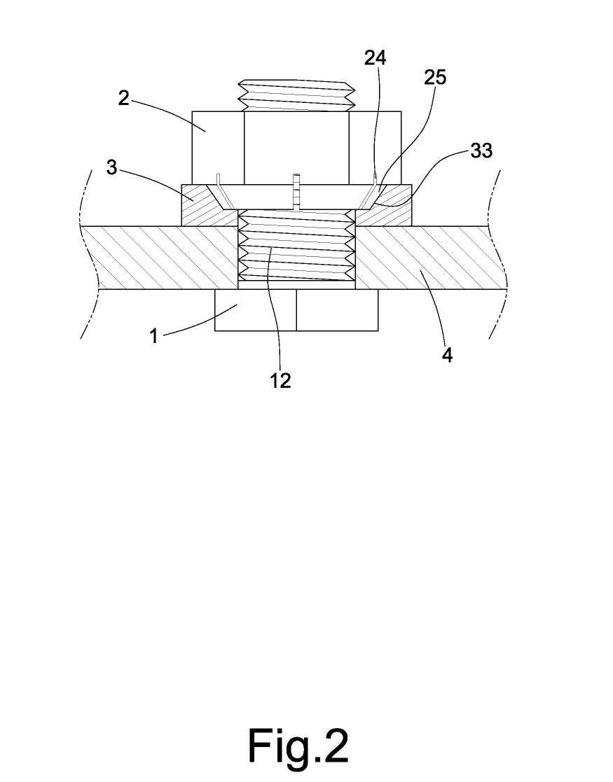

Referring to FIG. 2, the screw 1 penetrates an object 4, the central hole 31 of the spacer 3 and the through hole 21 of the nut 2, and then the nut 2 is screwed to fasten the screw and nut assembly. The annular fastening portion 23 is received in the annular concave portion 32. The annular concave portion 32 is opposing the screw head 11.

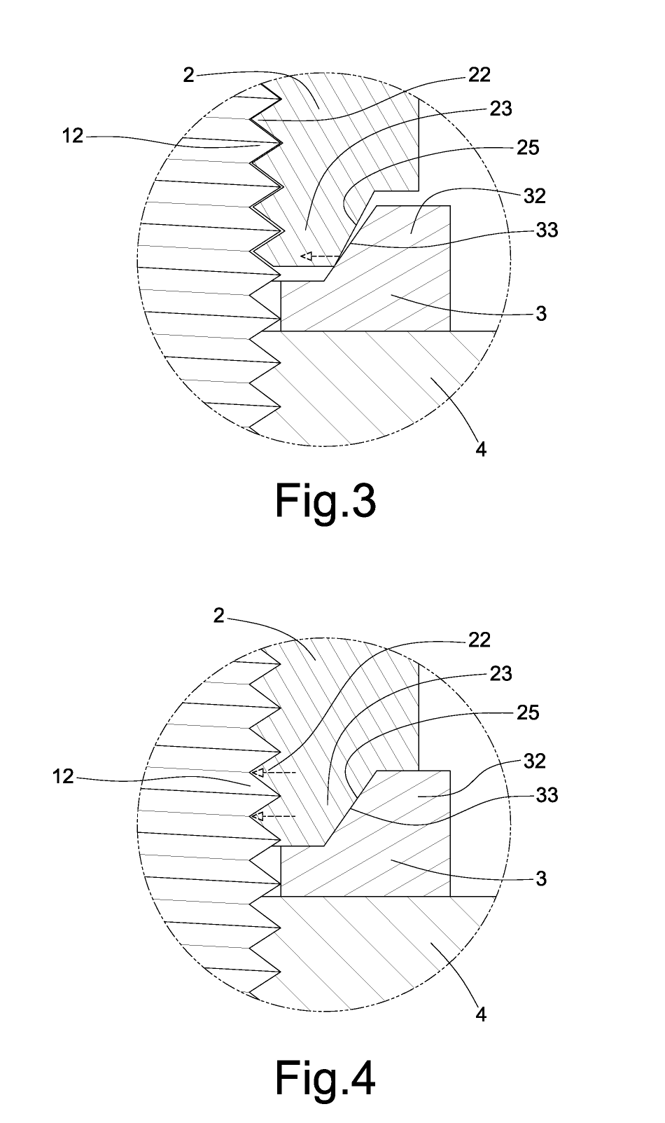

Referring to FIG. 3, when the screw 1 and the nut 2 are gradually locked, the nut 2 is moved toward the spacer 3. The annular fastening portion 23 of the nut 2 is confined by the annular concave portion 32 of the spacer 3 and pressed inward. Through the grooves 24, the annular fastening portion 23 is compressed inward, so that the inner edge of the annular fastening portion 23 tightly engages with the outer threaded body 12 of the screw 1, as shown in FIG. 4, to prevent disengagement.

For the annular fastening portion 23 to be compressed inward, the side surface 25 of the annular fastening portion 23 and the side surface 33 of the spacer 3 are at different angles, such that the side surface 33 assists the annular fastening portion 23 to be compressed inward.

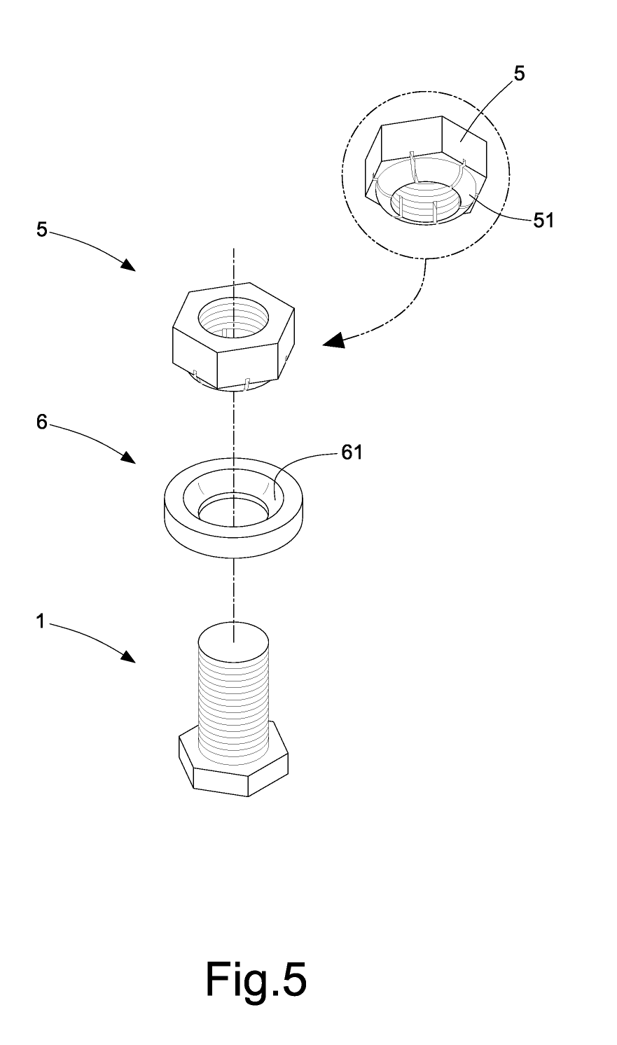

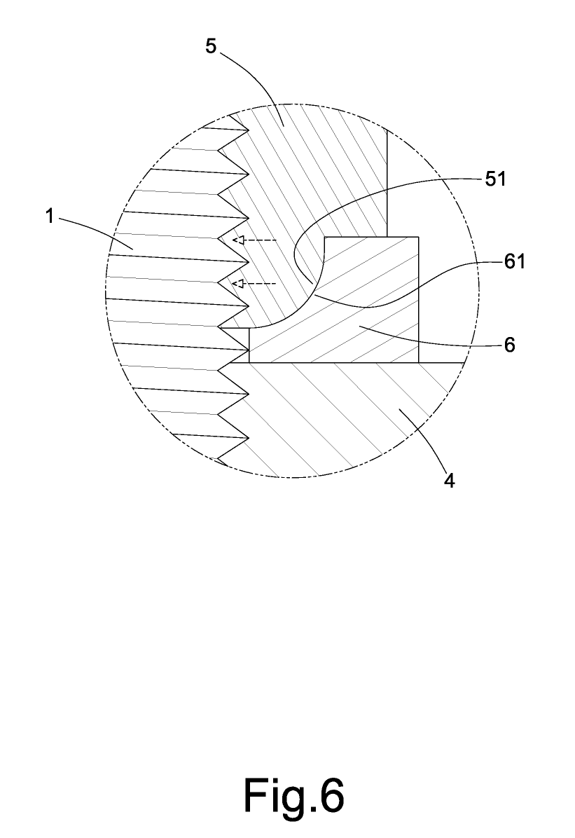

FIGS. 5 and 6 show a second embodiment of the present invention, which is substantially similar to the first embodiment with the exceptions described hereinafter. The annular fastening portion 51 of the nut 5 and the annular concave portion 61 of the spacer 6 are made in the shape of a bowl. The annular fastening portion 23, 51 and the annular concave portion 32, 61 can be in different shapes, not limited to the aforesaid.

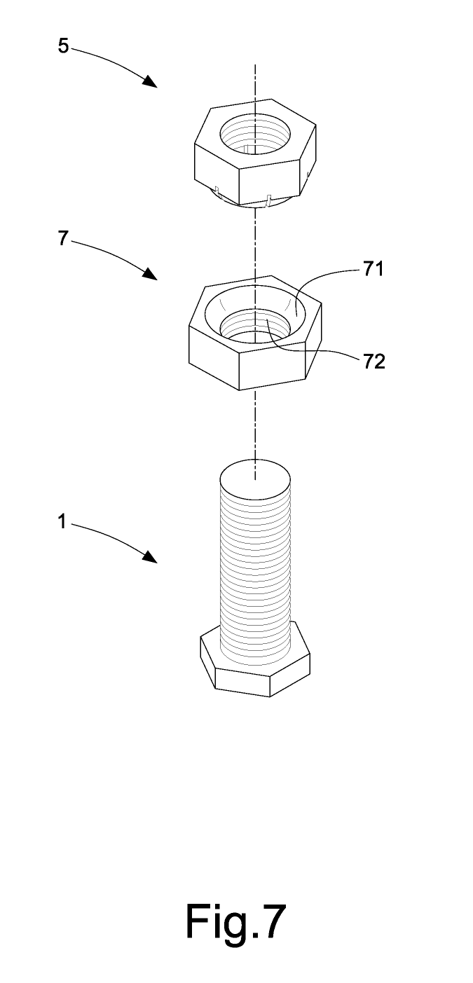

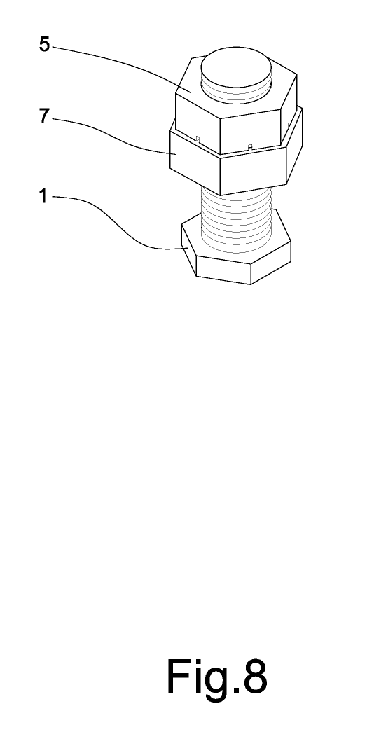

FIGS. 7 and 8 show a third embodiment of the present invention, which is substantially similar to the first embodiment with the exceptions described hereinafter. The spacer 7 has the annular concave portion 71 and inner threads 72 which mates with the screw 1. When the nut 5 is screwed to the screw 1, the spacer 7 can be adjusted on the screw 1 by means of the inner threads 72. Particularly, the nut 5 is against the spacer 7 to prevent disengagement.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A screw and nut assembly, comprising:
a screw, the screw comprising a screw head and an outer threaded body connected to one end of the screw head;
a nut, the nut having a central through hole and inner threads on an inner wall of the through hole for connection of the outer threaded body, the nut further having an annular fastening portion extending from one end thereof, the annular fastening portion having a plurality of grooves thereon; and
a spacer, the spacer having a central hole for insertion of the outer threaded body and an annular concave portion next to the central hole;
thereby, the annular concave portion being opposing the screw head, the screw penetrating the central hole of the spacer and the through hole of the nut, and the annular fastening portion being received in the annular concave portion, the nut being tightly screwed to the screw.

2. The screw and nut assembly as claimed in claim 1, wherein the annular fastening portion has an outer side which is gradually reduced toward a distal end thereof.

3. The screw and nut assembly as claimed in claim 1, wherein the grooves are equally spaced.

4. The screw and nut assembly as claimed in claim 1, wherein the grooves are disposed in a radial form.

5. The screw and nut assembly as claimed in claim 1, wherein, the annular fastening portion has a side surface and a bottom surface which is connected with a lower edge of the side surface.

6. The screw and nut assembly as claimed in claim 5, wherein the annular concave portion includes a side surface and a lower surface.

7. The screw and nut assembly as claimed in claim 6, wherein the side surface of the annular fastening portion and the side surface of the spacer are at different angles.

8. The screw and nut assembly as claimed in claim 1, wherein the annular fastening portion of the nut and the annular concave portion of the spacer are in the shape of a bowl.

9. The screw and nut assembly as claimed in claim 1, wherein the annular fastening portion forces the annular concave portion to be compressed inward after the screw, the spacer and the nut are locked.

10. The screw and nut assembly as claimed in claim 1, wherein the spacer has inner threads inside.
